(19) United States
(12) Patent Application Publication
(10) Pub. No.: US 2026/0145547 A1
(43) Pub. Date: May 28, 2026

(54) VEHICLE AXLE OF A TWO-TRACK VEHICLE

(71) Applicant: AUDI AG, Ingolstadt (DE)

(72) Inventor: Andreas GAßNER, Abensberg (DE)

(21) Appl. No.: 19/397,733

(22) Filed: Nov. 21, 2025

(30) Foreign Application Priority Data
Nov. 22, 2024 (DE) 102024134497.0

(51) Int. Cl. B60L 15/20; B60K 1/00; B60K 17/16

(52) U.S. Cl. CPC B60L 15/20; B60K 1/00; B60K 17/165; B60L 2240/486

(57) ABSTRACT

A vehicle axle of a two-track vehicle is provided, with an axle differential, which is connectable, on the input side, to a primary drive unit, and which is connectable, at the output, to vehicle wheels of the vehicle axle via output shafts arranged on both sides, wherein the vehicle axle has an electric motor and a superposition gearbox for electric torque vectoring, and wherein the electric motor can be actuated by way of a control unit in order to change a drive torque distribution to the vehicle wheels. The control unit is assigned an evaluation module, which carries out a backlash measurement on the superposition gear set in order to determine aging of a superposition gear set.

### BACKGROUND

### Technical Field

The disclosure relates to a vehicle axle of a two-track vehicle and to a method for determining aging of a superposition gear set in such a vehicle axle.

### Description of the Related Art

In a generic vehicle axle, an axle differential is installed which is connectable, on the input side, to a primary drive unit (for example, an electric machine), and which is connectable, at the output, to vehicle wheels of the axle via output shafts arranged on both sides. Such a generic vehicle axle also has electric torque vectoring provided with a secondary drive unit (electric motor) and a superposition gearbox. A control unit is used to actuate the electric motor with a torque. The torque distribution to the vehicle wheels can be varied depending on the magnitude and/or direction of rotation of said torque.

The superposition gear set must provide a very high gear ratio of, for example, 50:1. This high gear ratio is implemented through a series of gear stages and planetary gear sets in the superposition gearbox, which are subject to manufacturing tolerances, leading to significant backlash in the superposition gear set. The backlash must be transferred in a controlled manner by the electric motor during a quadrant change during driving operation. Furthermore, the backlash changes with increasing wear or with aging of the superposition gear set. This changes the duration of the quadrant change and how smoothly it occurs. In the prior art, aging of the superposition gear set is carried out by torque monitoring of the electric motor.

DE102021126647B3 discloses a drive unit for a motor vehicle in which, using a vibration compensation module, a vibration parameter is determined from the rotational speed of at least one component of a superposition gearbox, a vibration compensation control variable is determined from the vibration parameter, and the control signal of the electric motor is adjusted by the vibration compensation control variable.

DE102010021721A1 discloses a drive train for a motor vehicle in which, before starting off with the startup gear engaged, a backlash present in the transmission is compensated for by applying a small compensation torque, set at the friction clutch, to the gearbox input shaft.

DE102012011756A1 discloses a method that controls backlash in a vehicle's drive train during load changes by specifically regulating the transition from coasting to traction mode. In this case, the torque or rotational speed of the drive unit is adjusted so that the rotational speed difference from the reference speed at the docking point remains small, thus avoiding jerky docking. The backlash, which is either known from the component or determined during operation, is used for precise control to ensure smooth torque transmission.

### BRIEF SUMMARY

Embodiments of the present invention provide a vehicle axle of a two-track vehicle, and a method by way of which, in comparison to the prior art, an easy-to-carry-out aging determination of a superposition gear set in the vehicle axle can be carried out.

The disclosure relates to a vehicle axle of a two-track vehicle with an axle differential, which is connectable, on the input side, to a primary drive unit and which is connectable, at the output, to vehicle wheels of the vehicle axle via output shafts arranged on both sides. The vehicle axle has an electric motor and a superposition gearbox for electric torque vectoring. The electric motor is actuated by way of a control unit to change the drive torque distribution to the vehicle wheels. Aging of the superposition gear set may be determined using the following measure: The control unit is assigned a diagnostic module, which carries out a backlash measurement on the superposition gear set in order to determine aging of the superposition gear set. Based on the backlash measurement, the diagnostic module can enable conclusions to be drawn about the aging or wear of the superposition gear set.

According to the disclosure, the electric motor determines the size of the angle of rotation required on the shaft to apply a predetermined limit torque. The electric motor carries out this determination in both directions of rotation. If wear occurs in the gear set, the distance is expanded over several measurements reflecting the wear. By comparing these values to a nominal value, the electric motor can compensate for gear set aging. Furthermore, it is possible to compensate for free play that the electric motor must cover when changing gears.

It should be emphasized that, during vehicle operation, steering behavior directly depends on how well the electric motor can compensate for gear set free play. The better the gear set free play is compensated, the better the steering behavior, because the moment of inertia can then be compensated directly without any pause.

The disclosure is therefore based on the fact that gear set aging leads to an increase in backlash. It is the aim of the disclosure to determine backlash, detect a change in backlash, and store it in a historical data log. Subsequently, it can be determined whether and to what extent the gear set has aged. On this basis, aging compensation for the gear set torque loss can be carried out.

In a particular embodiment, the electric motor applies a positive and applicable gear differential torque (e.g., 10 Nm gear differential torque) to the gear set during backlash measurement and stores the rotor shaft angular displacement if the electric motor exceeds the applicable gear differential torque. Furthermore, the electric motor applies a negative and applicable gear differential torque to the gear set during backlash measurement and stores the rotor shaft angular displacement if the electric motor exceeds the applicable gear differential torque.

During backlash measurement, the electric motor can apply both a maximum positive and applicable gear differential torque (e.g., 20 Nm gear differential torque) and a maximum negative and applicable gear differential torque to the gear set. Here, the electric motor can limit the gear differential torque (hereinafter generally referred to as the diagnostic torque), which is used for backlash measurement, to an applicable change gradient (e.g., 50 Nm/s).

From the two determined gear set angular displacements, the electric motor can calculate an absolute backlash (hereinafter referred to as the actual backlash) and store it as a historical data value and a measurement data block. In addition, a change in the actual backlash can be calculated from the two determined gear set angular displacements and stored as a historical data value and a measurement data block.

The diagnostic module can generate a histogram from the actual backlashes, in which the actual backlashes are entered over the vehicle running time and stored as historical data values and as a measurement value block. Alternatively and/or additionally, a histogram can be generated from the actual backlashes, in which the actual backlashes are entered over the vehicle's mileage and stored as historical data values and as a measurement value block.

Furthermore, the diagnostic module can generate a histogram from the actual backlashes, in which the temporal change in the actual backlashes over the vehicle running time is entered and stored as a historical data value and as a measurement value block. Alternatively and/or additionally, a histogram can be generated from the actual backlashes, in which the temporal change in the actual backlashes over the vehicle mileage is entered and stored as a historical data value and as a measurement value block.

Using an application switch, it is possible to select whether and which value of the backlash measurements (absolute value, change in absolute value, mean value from histogram, mean value of change from histogram) should be used as the source for determining the gear set torque loss. The backlash measurement can be started, for example, in a workshop via a diagnostic routine. It is possible that the backlash values determined over running time can be reset in the diagnostic routine. If the backlash measurement values are used to determine the gear set's aging, the maximum value possible that the backlash measurement can determine must be limited.

In a specific implementation, the backlash measurement in the diagnostic module compares an actual backlash with a nominal value stored in the diagnostic module. Based on this comparison, the control unit carries out an aging compensation of a gear set torque loss present in the superposition gearbox, which is taken into account when actuating the electric motor.

The backlash measurement can be carried out as part of a diagnostic routine, for example in a workshop, in which the vehicle wheels are locked. In a preferred process variant, the actual backlash can be detected using the following process steps according to which, in a first process step, the control unit actuates the electric motor with a predetermined diagnostic torque that depends on the current fed to the electric motor. This current is increased until the diagnostic torque is reached. When the diagnostic torque is reached, an angular displacement sensor detects a corresponding first angular displacement. In a second process step, the control unit actuates the electric motor in the opposite direction of rotation using the diagnostic torque. When the diagnostic torque is reached, the angular displacement sensor detects a corresponding angular displacement. The diagnostic module calculates the actual backlash from the sum of the absolute values of the first and second angular displacements.

To further increase the validity of the aging determination, at least one histogram can be generated in the diagnostic module, in which a number of actual backlashes are plotted in chronological order over the vehicle running time or over the vehicle performance. The histogram can be read out using a diagnostic module in the workshop. For example, in the histogram, the following can be plotted:

the absolute value of actual backlashes over the vehicle running time;

the absolute value of the actual backlashes over the vehicle mileage;

the change in the actual backlash over the vehicle running time; and/or

the change in the actual backlashes over the vehicle mileage.

### BRIEF DESCRIPTION OF THE SEVERAL VIEWS OF THE DRAWINGS

Exemplary embodiments of the disclosure are described hereinafter with reference to the appended figures.

FIGS. 1 and 2 show the structure and operation of the vehicle axle according to embodiments of the disclosure.

### DETAILED DESCRIPTION

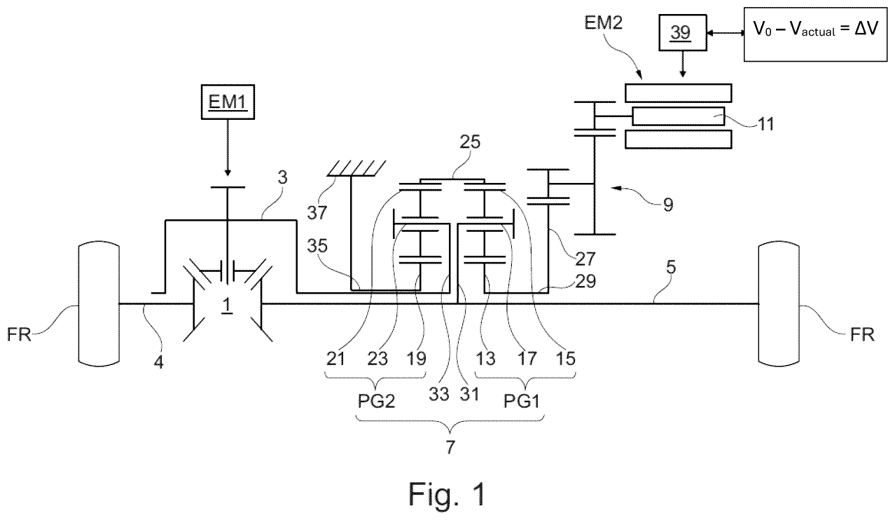

FIG. 1 shows the gear structure of, for example, an electrified rear axle of a two-track vehicle. The vehicle axle has an electric machine as its main drive EM1, which is operationally connected to the input side of an axle differential 1. From each of its output sides, an output shaft 4, 5 leads to one of the vehicle wheels FR of the vehicle axle. In FIG. 1, axle differential 1 is a bevel gear differential that has a drive-side differential housing 3, which contains compensating bevel gears as well as axle bevel gears, each of which is fixed against rotation on one of output shafts 4, 5.

The vehicle axle can carry out electric torque vectoring. For this purpose, the vehicle axle has a superposition gearbox 7 with an electric motor as an auxiliary drive EM2. In FIG. 1, superposition gearbox 7 consists of two planetary gears PG1, PG2 arranged axially next to one another and coupled to one another, which are aligned coaxially with output shafts 4, 5. Of the two planetary gears, an input-side planetary gear PG1 is operationally connected to rotor shaft 11 of electric motor EM2 via a countershaft stage 9. The input-side planetary gear PG1 has a sun gear 13, which is operationally connected to a radially outer ring gear 15 via planetary gears. The planetary gears are rotatably mounted on a rotating planetary gear carrier 17. Ring gears 15, 21 of two planetary gears PG1, PG2 are attached to a common ring gear shaft 25.

In the input-side planetary gear PG1, sun gear 13 forms an input element, which, together with a countershaft gear 27, is arranged in a rotationally fixed manner on a gearbox input shaft 29. Planetary gear carrier 17 of input-side superposition gearbox 1, in contrast, forms an output element, which is attached in a rotationally fixed manner to the gearbox-side output shaft 5 via a drive flange 31. In the output-side planetary gear PG2, the planetary gear carrier 23 forms an output element, which is attached to a gearbox output shaft 35 via a coupling flange 33. This gearbox output shaft 35, in turn, is attached in a rotationally fixed manner to the differential housing 3 of axle differential 1. Sun gear 19 of the second planetary gear PG2, in contrast, is attached to gearbox housing 37 in such a manner that it is fixed relative to the housing.

As is further apparent from FIG. 1, electric motor EM2 can be actuated with a torque by way of an electronic control unit 39. If electric motor EM2 is deactivated during driving operation, primary drive unit EM1 alone transmits a torque via axle differential 1 to the two vehicle wheels FR in a 50/50 distribution. Depending on the driving situation, control unit 39 can actuate electric motor EM2 with a torque. Depending on its size and/or direction of rotation, the torque distribution between the two vehicle wheels FR can be changed as needed, starting from the 50/50 distribution.

As is further apparent from FIG. 1, control unit 39 is assigned a diagnostic module 41, with which an aging determination of superposition gear set PG1, PG2 can be carried out using a backlash measurement. During the backlash measurement, in the diagnostic module 41, an actual backlash v_{actual} is compared with a nominal value v₀ stored in diagnostic module 41. The comparison results in a difference value Δv, based on which control unit 39 carries out an aging compensation of a gear set loss torque present in superposition gearbox 7. In addition, the wear of the superposition gear set can be determined, for example in a diagnostic routine that can be carried out in a workshop, based on the comparison between the actual backlash v_{actual} and the nominal value v₀.

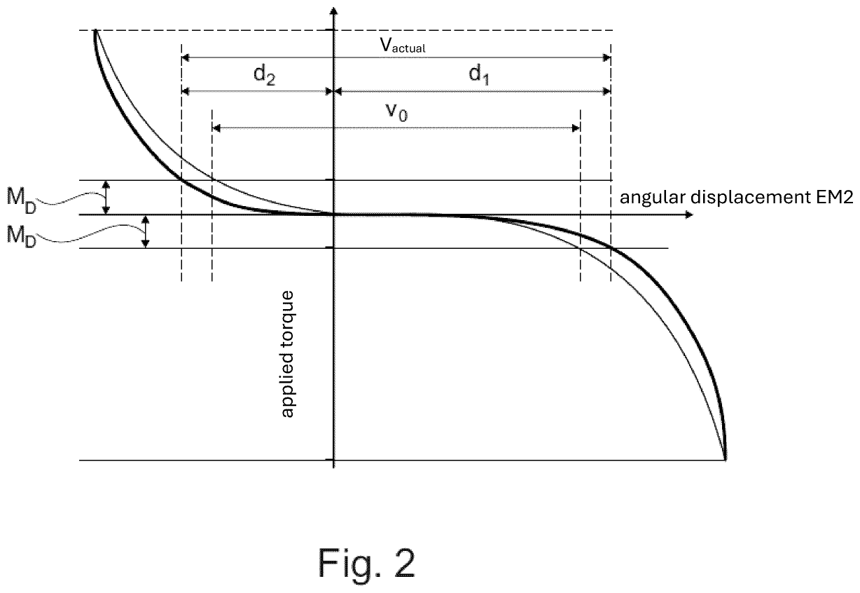

In conjunction with the diagram shown in FIG. 2, the process steps for determining the actual backlash v_{actual} are set forth below: First, in preparation for the backlash measurement, vehicle wheels FR are blocked. Then, in a first process step, control unit 39 actuates electric motor EM2 with a predetermined diagnostic torque M_{D}, which depends on the current fed into electric motor EM2. This current is increased until the diagnostic torque M_{D} is reached. When diagnostic torque M_{D} is reached, an angular displacement sensor 43 of electric motor EM2 detects a corresponding motor shaft angular displacement α₁. In a second process step, control unit 39 actuates electric motor EM2 in the opposite direction of rotation with diagnostic torque M_{D}. When diagnostic torque M_{D} is reached, angular displacement sensor 43 detects a corresponding second rotor shaft angular displacement α₂. Diagnostic module 41 calculates actual backlash v_{actual} from the sum of the absolute values of first and second rotor shaft angular displacements α₁, α₂.

German patent application no. 102024134497.0, filed Nov. 22, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A vehicle axle of a two-track vehicle having a primary drive unit and vehicle wheels, the vehicle axle comprising:
an axle differential, which is connectable, on an input side, to the primary drive unit, and which is connectable, at an output, to the vehicle wheels via output shafts arranged on both sides;
an electric motor; and
a superposition gearbox for electric torque vectoring,
wherein the electric motor can be actuated by a control unit to change a drive torque distribution to the vehicle wheels, and
wherein the control unit is assigned an evaluation module, which carries out a backlash measurement on the superposition gear set to determine aging of a superposition gear set.

2. The vehicle axle according to claim 1, wherein during the backlash measurement in the evaluation module, an actual backlash (v_{actual}) is comparable with a nominal value (v₀) stored in the evaluation module.

3. The vehicle axle according to claim 2, wherein on the basis of a comparison between the actual backlash (v_{actual}) and the nominal value (v₀), the control unit carries out an aging compensation of a gear set loss torque present in the superposition gearbox.

4. The vehicle axle according to claim 1, wherein the backlash measurement is carried out as part of a diagnostic routine in which the vehicle wheels are locked.

5. The vehicle axle according to claim 4, wherein the actual backlash (v_{actual}) can be determined by:
the control unit actuates the electric motor with a predetermined diagnostic torque (M_{D}), while an angular displacement sensor detects a corresponding first rotor shaft angular displacement (α₁) when the diagnostic torque (M_{D}) is reached, and
the control unit actuates the electric motor in the opposite direction of rotation using the diagnostic torque (M_{D}), while the angular displacement sensor detects a corresponding second rotor shaft angular displacement (α₂) when the diagnostic torque (M_{D}) is reached.

6. The vehicle axle according to claim 5, wherein the evaluation module calculates the actual backlash (v_{actual}) from the sum of the absolute values of the first and the second rotor shaft angular displacements (α₁, α₂).

7. The vehicle axle according to claim 1, wherein in the evaluation module, at least one histogram can be generated in which a number of actual backlashes (v_{actual1}, v_{actual2} . . . ) are plotted in a chronological order over a vehicle running time or over a vehicle performance.

8. The vehicle axle according to claim 7, wherein in the histogram, the following is plotted:
an absolute value of the actual backlashes (v_{actual1}, v_{actual2} . . . ) over the vehicle running time;
an absolute value of the actual backlashes (v_{actual1}, v_{actual2} . . . ) over the vehicle mileage;
a change in the actual backlashes over the vehicle running time; and/or
a change in the actual backlashes over the vehicle mileage.

9. A method carried out by a two-track vehicle having a primary drive unit, vehicle wheels and a vehicle axle, the vehicle axle including: an axle differential, which is connectable, on an input side, to the primary drive unit, and which is connectable, at an output, to the vehicle wheels via output shafts arranged on both sides; an electric motor; and a superposition gearbox for electric torque vectoring, the method comprising:
carrying out, via an evaluation module of a control unit, a backlash measurement on the superposition gear set to determine aging of a superposition gear set; and
actuating, via the control unit, the electric motor to change a drive torque distribution to the vehicle wheels.
